(19) United States
(12) Patent Application Publication
(10) Pub. No.: US 2015/0233726 A1
(43) Pub. Date: Aug. 20, 2015

(54) VISITING PLAN CREATING SYSTEM, TERMINAL DEVICE, AND VISITING PLAN CREATING METHOD

(71) Applicant: HONDA MOTOR CO., LTD., Tokyo (JP)

(72) Inventors: Tomoko HANDA, Kawagoe-shi (JP); Hiromitsu YUHARA, Tokyo (JP); Kazuya TAMURA, Tokyo (JP)

(21) Appl. No.: 14/614,782

(22) Filed: Feb. 5, 2015

(30) Foreign Application Priority Data
Feb. 20, 2014 (JP) 2014-030193

(51) Int. Cl. G01C 21/36; G06Q 10/10

(52) U.S. Cl. CPC G01C 21/3667; G06Q 10/1095

(57) ABSTRACT

With a visiting plan creating system, after candidate site data have been stored in a candidate site DB as a result of an operation performed by a user on an operating unit of a terminal, if a destination area is designated by the user, on a display unit, popup icons indicative of the candidate sites and genre-categorized tags are displayed on a map screen of the destination area. If the user operates the operating unit to select some of the popup icons, a visiting spot display item corresponding to each of the selected popup icons is fitted in the order of selection in a schedule display, and a travel path between the candidate sites is displayed on the map screen.

### CROSS-REFERENCE TO RELATED APPLICATION

This application is based upon and claims the benefit of priority from Japanese Patent Application No. 2014-030193 filed on Feb. 20, 2014, the contents of which are incorporated herein by reference.

### BACKGROUND OF THE INVENTION

1. Field of the Invention:

The present invention relates to a visiting plan creating system, a terminal device, and a visiting plan creating method that support a user of the terminal device in creating a visiting plan for the user to visit spots such as tourist spots, gourmet spots, and the like. In particular, the present invention concerns a visiting plan creating system, a terminal device, and a visiting plan creating method, which, when a user operates the terminal device and designates a destination area, are capable of preferentially selecting and displaying candidate sites inside of the destination area, from among spots (candidate sites that serve as visiting spots) which the user have recorded beforehand with interest, and also are capable of easily adjusting a visiting plan that includes a combination of the displayed visiting spots, a schedule of visits, and a travel path between the visiting spots.

2. Description of the Related Art:

For example, in Japanese Laid-Open Patent Publication No. 2001-195459, there is disclosed a travel itinerary system including a support tool that aides the user when creating a visiting plan for sightseeing and the like.

As disclosed in Japanese Laid-Open Patent Publication No. 2001-195459, for the user to create a travel itinerary, destinations that the user desires to visit are searched in each case from an information palette, and are displayed on a screen as a spot name list. For this purpose, in the case that desired spots are selected on the spot name list by the user operating a mouse or the like, the terminal device acquires and displays, on the screen, spot information in relation to the selected spots and map data of the surrounding area. By the same procedure, by the user sequentially determining a given number of destinations, a travel path is shown on the map that is displayed on the screen, and therefore the terminal device is capable of supporting the user in creating a travel itinerary.

### SUMMARY OF THE INVENTION

With the aforementioned conventional technique, using the terminal device which is a computer, the user can create a travel itinerary while sequentially confirming information of the destinations, and thus, use of the terminal device is highly rational and convenient. However, with such a method, there is a problem in that “enjoyment in the process of spending time selecting destination spots” which is a major factor in the fun of travel could be lost.

More specifically, for example, when planning a trip, from several weeks prior to commencing the trip, the user becomes interested in selecting spots (visiting spots) that the user desires to visit, and there is great enjoyment in checking various visiting spots from among tourist attractions, museums, and shops (gourmet spots) in which the user has developed an interest by way of gourmet information, etc. Further, during the trip, in the case that activities are undertaken together with a companion such as a friend or the like, one source of great enjoyment takes place in making adjustments to one's schedule, including activities of selecting, from among spots that one has a preference for, which spots are to be treated as visiting spots, or which spots are to be removed from the visiting spots (to give up on visiting), even though such an adjustment operation may involve considerable time and effort.

On the other hand, when creating a travel itinerary, since a large amount of information is drawn upon, it may possibly occur that one will forget to enter, into the travel itinerary, tourist spots and gourmet spots that, in one's daily life, one has shown an interest in, regardless of whether it is the most recent travel, and will later regret that such spots were not visited.

The present invention has been devised taking into consideration the aforementioned problems, and has the object of providing a visiting plan creating system, a terminal device, and a visiting plan creating method which, without sacrificing or losing the enjoyment that the user experiences in spending time selecting various visiting spots, enables visiting spots to be easily selected from within a destination area to thereby create a visiting plan.

The present invention relates to a visiting plan creating system, a terminal device, and a visiting plan creating method, which support a user of the terminal device in creating a visiting plan for visiting desired spots, based on data that are displayed on a display unit of the terminal device by way of two-way communications between a server and the terminal device.

In addition, for achieving the above object, the visiting plan creating system includes a candidate site data searching unit, a candidate site storage unit, a candidate site display processor, and a guidance display processor.

The candidate site data searching unit, as a result of an operation performed by a user on an operating unit of the terminal device, searches spot data corresponding to the operation from among a plurality of spot data indicative of spots capable of serving as visiting spots for the user, and sets the searched spot data as candidate site data indicative of candidate sites that match preferences of the user.

The candidate site storage unit establishes a linkage between the candidate site data and position information of the candidate sites and stores the candidate site data and the position information.

The candidate site display processor, when the user operates the operating unit and designates a destination area that the user desires to visit, based on the position information of the candidate sites linked therewith, preferentially searches candidate site data indicative of candidate sites inside of the destination area from among the candidate site data that are stored in the candidate site storage unit, and applies genre-categorized tags to the searched candidate site data in order to identify types of the visiting spots, and displays popup icons of the candidate site data on a map screen of the destination area that is shown on the display unit.

The guidance display processor, when the user operates the operating unit to select some of the candidate site data that are displayed by the popup icons on the map screen, fits a display label corresponding to each of the selected candidate site data in a schedule table formed on a time axis in the order of selection, and displays the schedule table on the display unit, and according to a fitted order of the display labels, is capable of displaying on the map screen a travel path between the candidate sites indicated by the display labels.

Further, for achieving the above object, the terminal device further includes, in addition to the display unit and the operating unit, the candidate site data searching unit, the candidate site display processor, and the guidance display processor.

Furthermore, for achieving the above object, the visiting plan creating method includes the following first through fourth steps.

The first step includes searching, as a result of an operation performed by the user on an operating unit of the terminal device, spot data corresponding to the operation from among a plurality of spot data indicative of spots capable of serving as visiting spots for the user, and setting the searched spot data as candidate site data indicative of candidate sites that match preferences of the user.

The second step includes establishing a linkage between the candidate site data and position information of the candidate sites, and storing the candidate site data and the position information in a candidate storage unit.

The third step includes, when the user operates the operating unit and designates a destination area that the user desires to visit, based on the position information of the candidate sites linked therewith, preferentially searching candidate site data indicative of candidate sites inside of the destination area from among the candidate site data that are stored in the candidate site storage unit, and applying genre-categorized tags to the searched candidate site data in order to identify types of the visiting spots, and displaying popup icons of the candidate site data on a map screen of the destination area that is shown on the display unit.

The fourth step includes, when the user operates the operating unit to select some of the candidate site data that are displayed by the popup icons on the map screen, fitting a display label corresponding to each of the selected candidate site data in a schedule table formed on a time axis in the order of selection, displaying the schedule table on the display unit, and according to a fitted order of the display labels, displaying on the map screen a travel path between the candidate sites indicated by the display labels.

According to the inventions described above, from a time at which the user undertakes the creation of a visiting plan for a trip or the like, spot information that has been researched in various ways over a wide area, and visiting spots such as tourist spots, gourmet spots, and museums or the like, which the user has always longed to visit, are stored in the candidate site storage unit as candidate site data indicative of candidate sites that match with the preferences of the user. In addition, when the user designates a destination area that the user actually desires to visit, genre-categorized tags are applied to the candidate site data concerning candidate sites that are positioned inside of the destination area, and popup icons of the candidate sites are displayed on a map screen of the destination area. Consequently, the positions of the candidate sites and the types (genres) of the candidate sites on the map screen can be used as a reference or guide, and by the user operating the operating unit, visiting spots including the order in which they are to be visited can easily be selected.

Accordingly, spots in which the user has shown interest are stored in the candidate site storage unit as the candidate site data, and since the popup icons are displayed on the map screen by the candidate site display processor, in creating a visiting plan, such spots can reliably be established as selections under consideration, i.e., deserving of further study, by the user. Further, from the genre-categorized tags of the candidate sites and the positional relationship between the candidate sites on the map screen, a combination of respective candidate sites in the order in which the sites are to be visited can easily be selected.

Furthermore, display labels corresponding to the respective candidate site data (information of the visiting spots) are fitted and displayed, in the order in which they are to be visited, in the schedule table that is displayed with a time axis, and since a travel path between the respective candidate sites in the visiting order thereof is displayed on the map screen, the user can easily grasp an image of such movements and the approximate time required therefor.

Consequently, according to the present invention, without sacrificing the enjoyment that the user experiences in spending time selecting various visiting spots, the visiting spots can easily be selected from within a destination area to thereby create a visiting plan.

The guidance display processor is capable of changing a display order in which a plurality of the display labels are displayed along the time axis in the schedule table, corresponding to an operation of the operating unit made by the user, and the travel path between the candidate sites displayed on the map screen may be changed and displayed responsive to the change in the display order. In accordance with this feature, since by operating the operating unit, the user can easily carry out an operation to interchange or swap the visiting order of the respective candidate sites, any number of schedules can easily be created and considered.

Further, preferably, the guidance display processor is capable of adjusting a time width and a display position of each of the display labels in the schedule table, corresponding to a residence time of the user in the candidate site indicated by each of the display labels in the schedule table, and a travel time of the user between the candidate sites. In this manner, since the time widths and the display positions of the respective display labels can be adjusted corresponding to the residence time and the travel time, it is possible to increase the timewise precision of the visiting plan that is displayed in the schedule table. As a result, by the user confirming the schedule table, a temporal image of the created visiting plan can easily be grasped.

Furthermore, candidate site data that has been selected by the user from among the candidate site data displayed by the popup icons can be deleted by deleting a corresponding popup icon from the map screen or by deleting a corresponding display label from the schedule table, as a result of an operation of the operating unit performed by the user. Accordingly, candidate site data can easily be deleted from both a positional standpoint on the map screen and a temporal standpoint in the schedule table.

Further still, the display unit may display the schedule table and the map screen side by side, and may display in association with each other, respectively, the display labels in the schedule table together with the candidate site data and the genre-categorized tags that are displayed on the map screen. Accordingly, the visiting plan can be adjusted while comparing the positions of the candidate sites on the map screen with the positions of the display labels in the schedule table. Further, by associating the display labels with the candidate site data corresponding to the candidate sites and the genre-categorized tags, since it is possible to display both of them in alignment, the positional confirmation of both items is extremely easy. For example, by using partial content of the display labels in association with the displayed content of the genre-categorized tags, candidate site data to which the genre-categorized tags have been applied can easily be distinguished from other candidate site data.

As described above, according to the present invention, without sacrificing the enjoyment that the user experiences in spending time selecting various visiting spots, the visiting spots can easily be selected from within a destination area to thereby create a visiting plan.

The above and other objects features and advantages of the present invention will become more apparent from the following description, when taken in conjunction with the accompanying drawings in which a preferred embodiment of the present invention is shown by way of illustrative example.

### BRIEF DESCRIPTION OF THE DRAWINGS

FIG. 1 is a block diagram showing in outline the configuration of a visiting plan creating system according to an embodiment of the present invention;

FIG. 2 is a flowchart of a process flow that takes place when a client terminal shown in FIG. 1 acquires a distribution setting program from a distribution server;

FIG. 3 is a flow chart showing a visiting plan creating method;

FIG. 4 is an explanatory drawing in which an example is shown of a main screen for bookmarking spots of an arbitrary region;

FIG. 5 is an explanatory drawing in which an example is shown of a bookmark screen in which bookmarked spots of destination areas are displayed;

FIG. 6 is an explanatory drawing in which an example is shown of a map screen in which a destination area is displayed for the purpose of creating a visiting plan;

FIG. 7 is an explanatory drawing showing a case in which a candidate site displayed by way of a popup icon on the map screen is added to the visiting plan;

FIG. 8 is an explanatory drawing showing a case in which candidate sites that have been added to the visiting plan are displayed by way of popup icons on the map screen;

FIG. 9 is an explanatory drawing showing a case in which a name and a date of the visiting plan are input;

FIG. 10 is an explanatory drawing showing a case in which the map screen and a schedule table are displayed alongside one another;

FIG. 11 is an explanatory drawing showing a case in which a travel path between visiting spots is displayed on the map screen;

FIG. 12 is an explanatory drawing showing a case in which the schedule display is in full screen;

FIG. 13 is an explanatory drawing showing a case in which a time width of a visiting spot display item of the schedule display is changed; and

FIG. 14 is an explanatory drawing showing a case in which an unneeded candidate site is deleted.

### DESCRIPTION OF THE PREFERRED EMBODIMENTS

A preferred embodiment of a visiting plan creating system and a terminal device according to the present invention will be described in detail below, in relation to a visiting plan creating method, with reference to the accompanying drawings.

### Configuration of an Embodiment

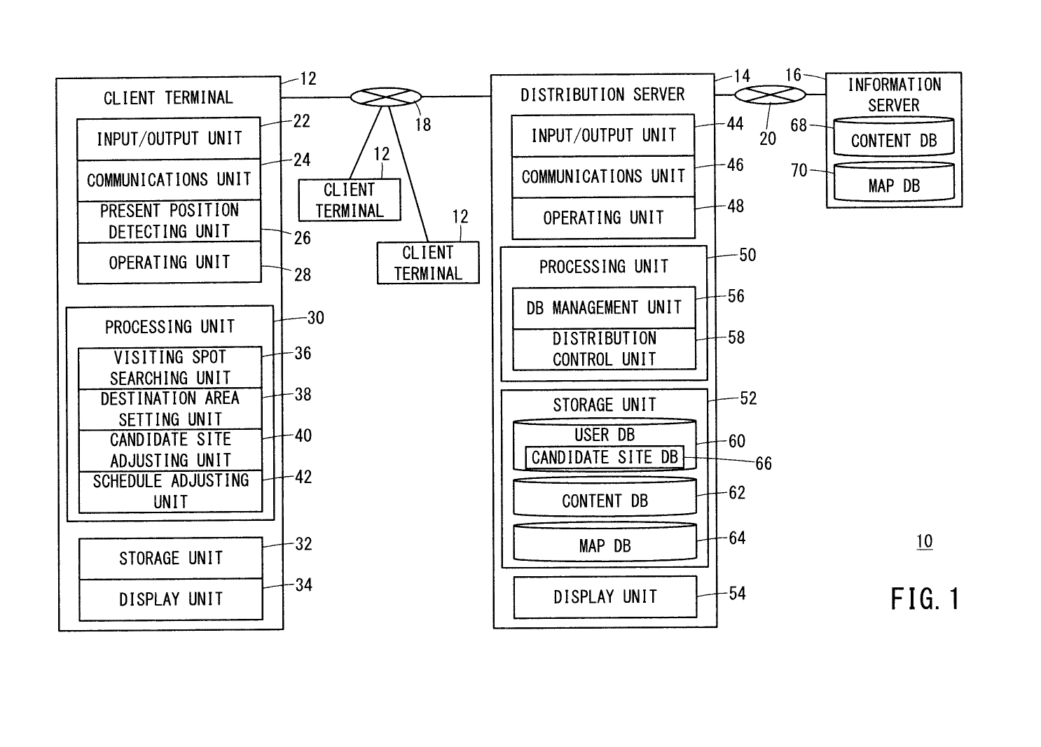

FIG. 1 is a block diagram showing in outline the configuration of a visiting plan creating system 10 (hereinafter referred to as a “system 10”) according to an embodiment of the present invention.

The system 10 includes a plurality of client terminals 12 (hereinafter referred to as “terminals 12”), a distribution server 14 (hereinafter referred to as a “server 14”), and an information server 16 (hereinafter referred to as a “server 16”). In the present embodiment, the respective terminals (terminal devices) 12 and the server 14 are capable of communicating via a communications network 18, whereas the server 14 and the server 16 are capable of communicating via a communications network 20.

The respective terminals 12 are commercially available smart phones, for example, each of which includes an input/output unit 22, a communications unit 24, a present position detecting unit 26, an operating unit 28, a processing unit 30, a storage unit 32, and a display unit 34. In FIG. 1, the input/output unit 22, the communications unit 24, the present position detecting unit 26, the operating unit 28, the processing unit 30, the storage unit 32, and the display unit 34 are illustrated representatively in relation to one terminal 12. However, it will be appreciated as a matter of course that the other terminals 12 are equipped with the same constituent elements.

The input/output unit 22 carries out input and output of signals in the terminal 12. The communications unit 24 carries out communications with the server 14 through a wireless or a wired link. The present position detecting unit 26 detects the present position of the terminal 12. The operating unit 28 comprises an input device such as a touch panel or the like by which user commands are input.

The processing unit 30 controls the respective components of the terminal 12, and is equipped with a visiting spot searching unit (candidate site data searching unit) 36, a destination area setting unit 38, a candidate site adjusting unit (candidate site display processor) 40, and a schedule adjusting unit (guidance display processor) 42. The visiting spot searching unit 36, the destination area setting unit 38, the candidate site adjusting unit 40, and the schedule adjusting unit 42 are formed by executing a later-described distribution setting program, and through a relationship with the server 14 (or the server 16), implements predetermined processes responsive to operations of the operating unit 28 performed by a user.

More specifically, in the case that the user operates the operating unit 28 while observing a screen of the display unit 34, and a search is performed of spots (spots in which the user has interest) for which a visit by way of traveling or the like is being considered from among various spots such as tourist spots, gourmet spots, museums or the like, the visiting spot searching unit 36 searches as to whether or not spot data indicative of spots corresponding to the operations exists in later-described content databases 62, 68 (hereinafter referred to as “content DBs 62, 68”) within the servers 14, 16. Additionally, if the search of the spot data was successful, the spot data that was searched for are linked with position information of spots (candidate sites) that match with the preferences of the user, as candidate data indicative of the candidate sites, and are stored in a later-described candidate site database 66 (hereinafter referred to as a “candidate site DB 66”).

In the spot data or the candidate site data, there are included spot names, images representative of the spots (e.g., exterior or interior images of tourist spots, gourmet spots, museums or the like), and comments in relation to the spots (e.g., recommendation information of the spots). Further, as for the position information of the spots or the candidate sites, for example, the later-described map databases 64, 70 (hereinafter referred to as “map DBs 64, 70”) may be searched for map information of the spot areas or the candidate site areas, and from the map information that was searched for, the position information may be acquired. Furthermore, this type of spot data and position information may be acquired, not from the content DBs 62, 68 and the map DBs 64, 70, but rather from various types of information on the Internet.

On the other hand, in the case that the user operates the operating unit 28 while observing the screen shown on the display unit 34, and regionally designates a destination (destination area) that the user wishes to visit, the destination area setting unit 38 acquires map information corresponding to the destination area from the map DBs 64, 70 of the servers 14, 16, and the acquired map information is shown on the display unit 34 as a map screen indicative of the destination area.

In this case, from among the candidate site data that are stored in the candidate site DB (candidate site storage unit) 66 in the server 14, the candidate site adjusting unit 40 searches for candidate site data preferentially, i.e., on a priority basis, corresponding to the candidate sites within the destination area, and acquires, from the server 14, the candidate site data that was searched for. Since map information of the destination area is acquired by the destination area setting unit 38, the candidate site adjusting unit 40 compares the map information with the position information that has been linked with the candidate site data, whereby from among the candidate site data that are stored in the candidate site DB 66, the candidate site adjusting unit 40 may search for candidate site data within the destination area.

In addition, the candidate site adjusting unit 40 applies genre-categorized tags (i.e., tags for distinguishing among types of tourist spots, gourmet spots, museums, etc.) for thereby identifying the types of spots (visiting spots) that the user desires to visit, and displays popup icons of the candidate site data on the map screen of the destination area that is shown on the display unit 34.

When the user operates the operating unit 28 while observing the screen shown on the display unit 34, and selects desired candidate site data from among the candidate site data displayed as the popup icons on the map screen, the schedule adjusting unit 42 fits display labels corresponding to the selected candidate site data, into a schedule table that is formed along a time axis, in the order in which such data was selected. The schedule table in which the display labels are fitted is displayed on the display unit 34. Further, according to the order in which the display labels are fitted into the schedule table, the schedule adjusting unit 42 displays a travel path between the candidate sites indicated by the display labels, on the map screen.

The storage unit 32 stores various programs such as a distribution setting program, a control program and the like, which are used by the processing unit 30, and data. Among the various types of data, user information of the user of the terminal 12 is included. Further, within the user information, user identifying information (user IDs) is included for specifying the user or the terminal 12. The display unit 34 displays various screens such as map screens or the like that are used in making the distribution settings. If the operating unit 28 is a touch panel, the operating unit 28 and the display unit 34 can be constituted as a single unit.

The server 14 is equipped with an input/output unit 44, a communications unit 46, an operating unit 48, a processing unit 50, a storage unit 52, and a display unit 54. The input/output unit 44 carries out input and output of signals in the server 14. The communications unit 46 carries out communications between the respective terminals and the server 16 through a wireless link or a wired link. The operating unit 48 comprises an input device such as a keyboard or the like by which commands from an administrator of the server 14 are input.

The processing unit 50 controls the respective components of the server 14, and is equipped with a database management unit 56 (hereinafter referred to as a “DB management unit 56”) and a distribution control unit 58. The DB management unit 56 manages the database that is included in the storage unit 52. The distribution control unit 58 controls the distribution of various information from the server 14 to each of the terminals 12.

The storage unit 52 stores various programs such as a control program and the like, which are used by the processing unit 50, and data. The storage unit 52 includes a user database 60 (hereinafter referred to as a “user DB 60”), the content DB 62, and the map DB 64.

The user DB 60 includes information (personal data) about users of the respective terminals 12. More specifically, for each of such users, information concerning the user is stored in the user DB 60. For example, the information concerning the user includes a user name, sex, date of birth (age), and a user ID. Further, the user DB 60 includes the candidate site DB 66 in which candidate site data are stored.

In the content DB 62, there are included, for example, various types of content such as music, various types of news, various articles, event information, and the like. Further, spot data indicative of various spots such as tourist spots, gourmet spots, museums, etc., are included in the content DB 62. The map DB 64 includes various types of map information (e.g., position information of the aforementioned tourist spots, gourmet spots, museums, etc.).

Accordingly, the visiting spot searching unit 36 searches the content DB 62 for spot data corresponding to an operation of the operating unit 28 made by the user, whereupon the spot data that was searched for is determined as the candidate site data, and is stored in the candidate site DB 66. At this time, the visiting spot searching unit acquires position information of the candidate sites with reference to the map DB 64, and a linkage is established between the candidate site data and the acquired position information of the candidate sites, and is stored in the candidate site DB 66.

The information server 16 includes the content DB 68 and the map DB 70. The content DB 68, similar to the content DB 62, includes various types of content and spot data. Further, the map DB 70, similar to the map DB 64, includes various types of map information.

The respective servers 14, 16 include the content DBs 62, 68 and the map DBs 64, 70, and therefore, in the following description, a case will be described in which the terminals 12 acquire various types of information from the content DB 62 and the map DB 64 of the server 14.

[Acquisition of Distribution Setting Program]

Next, various controls performed in the terminal and the server 14 for carrying out distribution of various information from the server 14 to a specified terminal 12 will be described. In the present embodiment, initially, the user acquires (downloads and installs) a distribution setting program using the terminal 12. The distribution setting program is a program for implementing distribution settings in the terminal 12.

The distribution setting program is included in a personal assist application program (PAAP), as one part of the PAAP. The PAAP is a program that operates in the terminal 12 in order to distribute, to the terminal 12, information corresponding to attributes (personal data) of respective users of the terminal 12.

After the PAAP, which includes the distribution settings program, has been acquired, the user operates the terminal 12 to input the distribution settings. When input of the distribution settings is completed, the distribution settings are sent to the server 14. The server 14 then distributes various information responsive to the distribution settings that were received from the terminal 12.

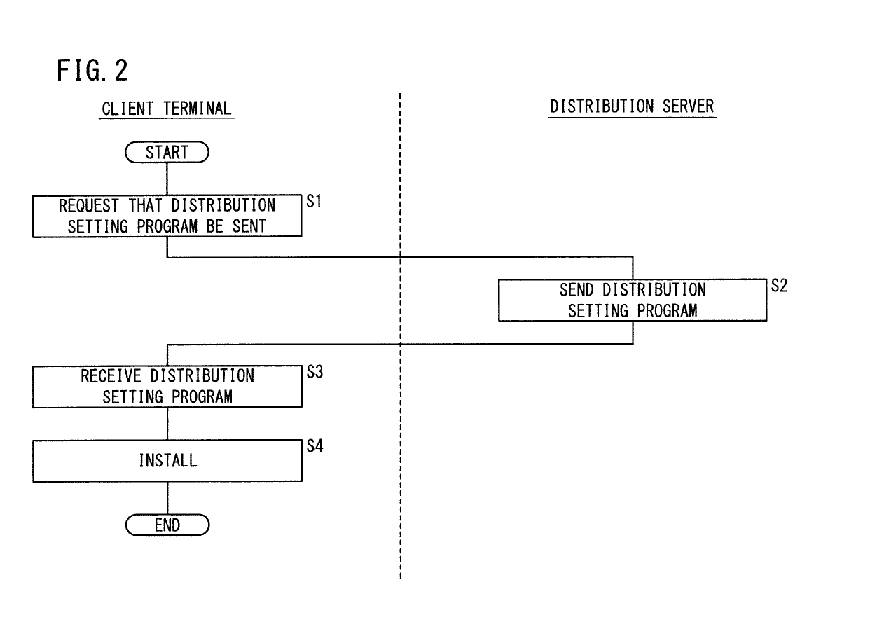

FIG. 2 is a flowchart of a process flow that takes place when the terminal 12 acquires the distribution setting program (PAAP) from the server 14. In step S1, the terminal 12 issues a request to the server 14 to send the distribution setting program, responsive to an operation of the operating unit 28 made by the user.

In step S2, in response to the request from the terminal 12, the server 14 sends the distribution setting program to the terminal 12. The distribution setting program is stored in the storage unit 52 of the server 14. In step S3, the terminal 12 receives the distribution setting program. In step S4, the terminal 12 installs the distribution setting program responsive to an operation of the operating unit 28 made by the user.

Acquisition of the distribution setting program is not limited to being received from the distribution server 14, and for example, the distribution setting program can be received in the form of an online shopping product through a website.

### Operations of the Present Embodiment

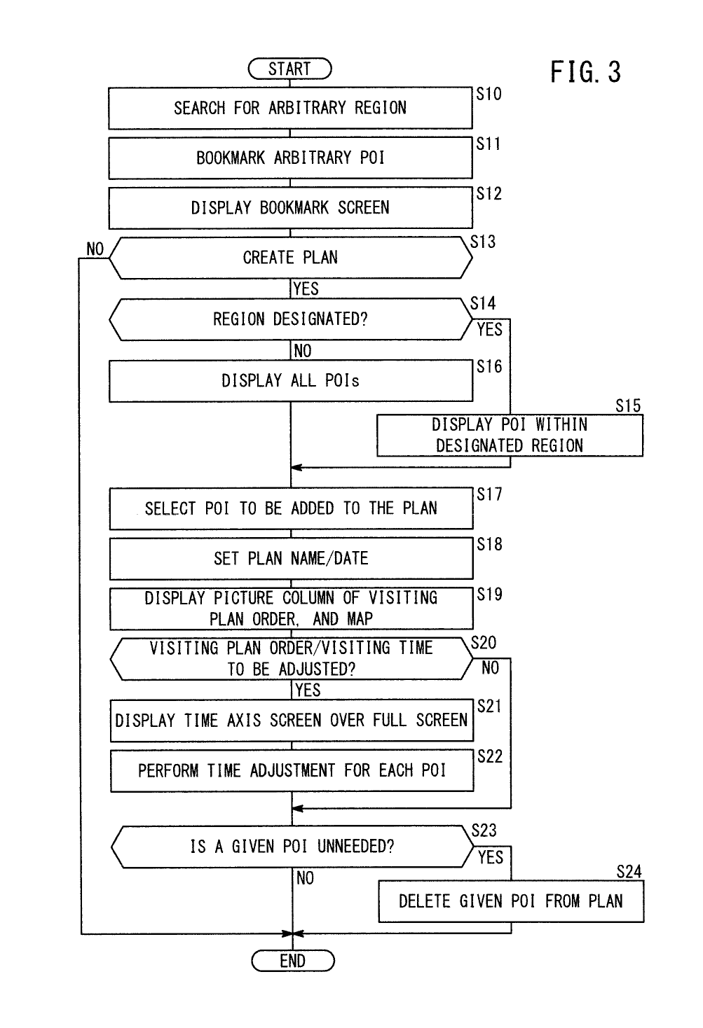

The system 10 according to the present invention is constructed as described above. Next, operations (a visiting plan creating method) of the system 10 will be described with reference to FIGS. 3 through 14.

FIG. 3 is a flow chart showing steps performed when the user operates the terminal 12, and creates a visiting plan for visiting various spots such as tourist spots, gourmet spots, museums, and the like.

Initially, the user operates the operating unit 28 of the terminal 12 (e.g., by selecting an icon) to start execution of the distribution setting program. The processing unit 30 of the terminal 12 shows on the display unit 34 a display screen (main screen), which notifies the user that the distribution setting program has started and thus a visiting plan can be created.

In step S10 (first step) of FIG. 3, the user observes the main screen of the display unit 34, and after having confirmed that a visiting plan can be created, operates the operating unit 28, and inputs an arbitrary region (e.g., area A), which is a destination that the user wants to visit. The visiting spot searching unit 36 makes a request to the server 14 so that map information of the input area A and information (spot data) on various spots such as tourist spots, gourmet spots, museums, etc., of the area A are distributed.

When the server 14 receives the request from the terminal 12, the distribution control unit 58 that constitutes the processing unit 50 of the server 14 distributes to the terminal 12 through the communications network 18 the map information of the area A that is stored in the map DB 64, and the spot data corresponding to spots in the vicinity of the area A that are stored in the content DB 62. The visiting spot searching unit 36 of the terminal 12 displays the received spot data on the main screen of the display unit 34.

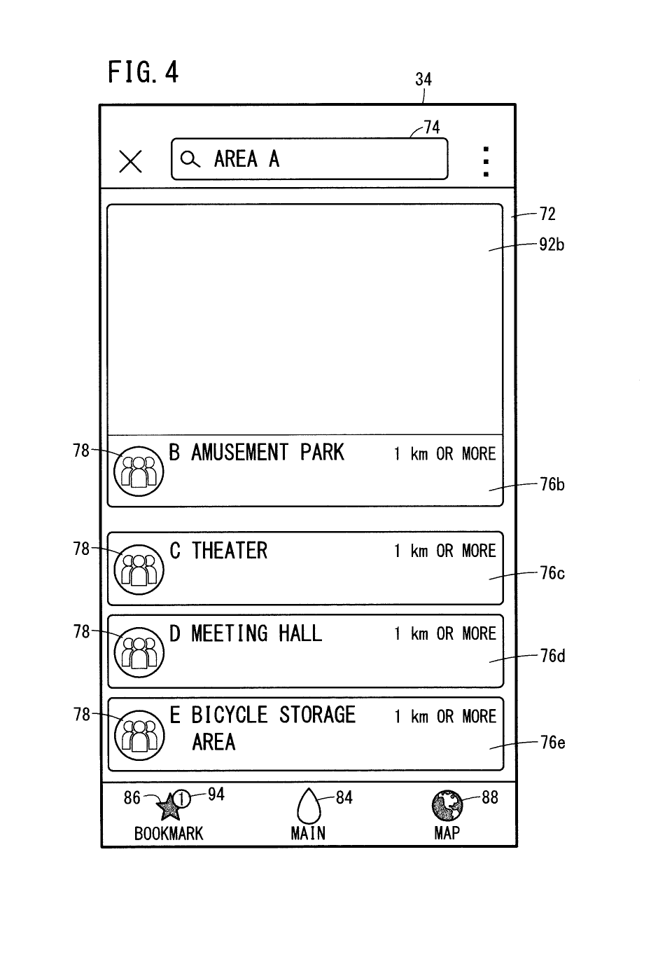

FIG. 4 is a drawing illustrating the main screen 72 that is shown on the display unit 34.

In the main screen 72, there are displayed alongside one another a text box 74 for inputting an arbitrary region such as the “area A”, etc., that serves as a subject to be searched, and spot display items 76b to 76e, which are displayed as a list on the main screen 72 in response to the “area A” having been input into the text box 74. In the spot display items 76b to 76e, the names of the respective spots within the area A (“B amusement park”, “C theater”, “D meeting hall”, “E bicycle storage area”, etc.) and distances of the respective spots with respect to a center position of the area A are displayed, and genre-categorized tags 78, which indicate the types (genres) of the respective spots, are displayed in an operable manner.

Further, among the respective spot display items 76b to 76e, in the spot display item for a spot that is highly popular or has high name recognition, for example, in the spot display item 76b for “B amusement park”, a display region 92b is shown at an enlarged scale continuous with the spot display item 76b. An image that symbolizes the spot display item 76b is displayed in the display region 92b. In FIG. 4, although an image of the “B amusement park” is shown in the display region 92b, the details of this image are omitted from illustration.

The names, distances, and images of the respective spots serve to define a portion of the spot data. Further, the genres corresponding to the genre-categorized tags 78 make be included in the spot data.

Furthermore, the main screen 72 can be scrolled up and down, so that spot display items that cannot all be shown on the screen can be sequentially switched through and displayed.

Since any one of the respective spots displayed in the spot display items 76b to 76e of FIG. 4 is a facility in relation to a tourist spot, the same genre-categorized tags 78 are applied to the respective spot display items 76b to 76e to indicate that they are tourist spots.

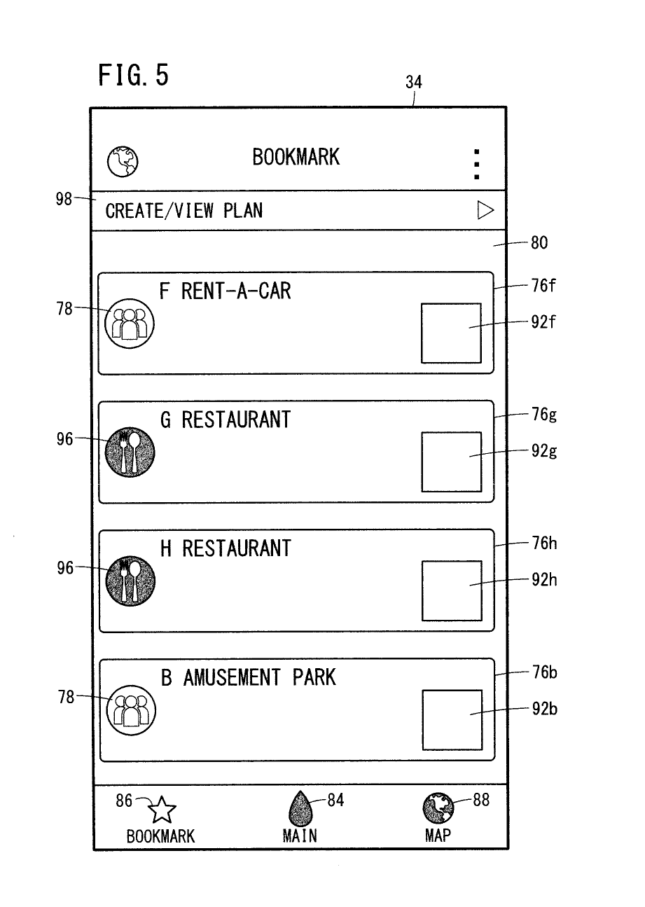

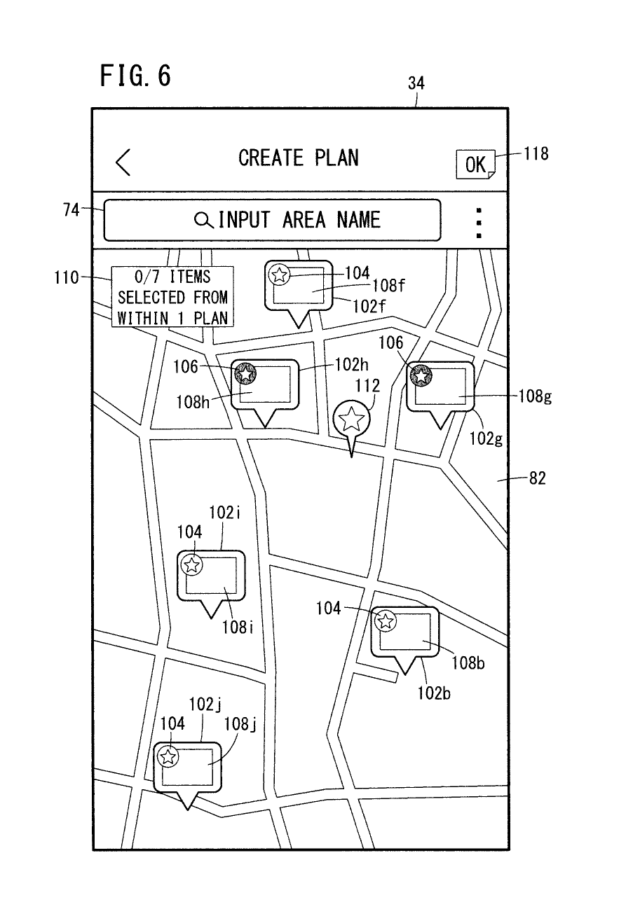

Below the main screen 72, selection buttons 84 to 88 are shown by which the user can selectively display any one of the main screen 72, a bookmark screen 80 of FIG. 5, or the map screen 82 of FIG. 6. In FIG. 4, since the main screen 72 is displayed, the selection button 84 corresponding to the main screen 72 is shown by way of a white void image (an outlined image), whereas the selection button 86 corresponding to the bookmark screen 80 and the selection button 88 corresponding to the map screen 82 are shown in color. Moreover, in FIGS. 4 through 8 and 10 through 14, only portions of the color displays are illustrated in black.

In the next step S11 (second step), a bookmarking operation is performed by the user to bookmark an arbitrary point of interest (POI).

In the main screen 72 of FIG. 4, when the user taps the spot display item 76b, content of another screen are switched to, in which detailed information corresponding to the spot display item 76b is shown. By browsing the screen information of the other screen, detailed information of the spot that was tapped on can be confirmed. Illustration of the detailed information displayed on the other screen is omitted.

In addition, in the case that the image of the “B amusement park” or the detailed information thereof is viewed, and the user feels that the “B amusement park” is a spot (interesting candidate site) in which the user has interest, the user taps on the genre-categorized tag 78, which is displayed in the spot display item 76b, whereby the “B amusement park” is marked as a POI.

More specifically, when the visiting spot searching unit 36 accepts the tap made by the user on the genre-categorized tag 78 of the spot display item 76b, it confirms that the “B amusement park” indicated by the spot display item 76b is a POI (candidate site) for the user, and it requests the server 14 to register the spot data of the “B amusement park” in the candidate site DB 66 of the server 14, through the communications network 18. Responsive to the request from the terminal 12, the DB management unit 56 of the server 14 registers the spot data of the “B amusement park”, which is stored in the content DB 62, in the candidate site DB 66 as candidate site data indicating a spot (candidate site) that matches with the preferences of the user. In this case, the DB management unit 56 refers to the map DB 64, and links the position information of the “B amusement park” with the candidate site data, and then registers the candidate site data and the linkage in the candidate site DB 66.

By a series of such processes, spot data of the “B amusement park” which is a POI is registered (bookmarked) as candidate site data in the candidate site DB 66. Moreover, in the candidate site DB 66, bookmarked candidate site data and position information thereof preferably are stored for each user (terminal 12).

Further, when the “B amusement park” is bookmarked, in the main screen 72 of FIG. 4, the visiting spot searching unit 36 newly displays in an overlapping manner on the selection button 86 a message 94, which indicates the number of spots (candidate sites) that have been bookmarked. In FIG. 4, the number “1”, which indicates that the one spot “B amusement park” has been bookmarked, is displayed as a message 94. Accordingly, if the user bookmarks multiple spots as POIs, then the number of spots that have been bookmarked is displayed in the message 94.

Next, in step S12, when the user taps on the selection button 86, in place of the main screen 72 of FIG. 4, the visiting spot searching unit 36 displays the bookmark screen 80 of FIG. 5 on the display unit 34.

As shown in FIG. 5, on the bookmark screen 80, spot display items (display labels) indicating the candidate sites are displayed from top to bottom in the order in which the spots were bookmarked (selected) by the user, for each of preset wide area sectors (e.g., for each of respective states or prefectures).

In FIG. 5, portions of a “wide area sector in which area A is included”, or more specifically, spot display items (display labels) 76f, 76g, 76h, 76b, which are indicative of candidate sites selected by the user, are displayed on the bookmark screen 80. Consequently, by observing the bookmark screen 80, the user can confirm that the recently bookmarked spot in the wide area including the “area A” is the “B amusement park”, which is indicated by the spot display item 76b.

Further, in the bookmark screen 80, the spot display items 76f, 76g, 76h correspond respectively to “F rent-a-car”, “G restaurant”, and “H restaurant”. Thus, genre-categorized tags 78 pertaining to tourist spots are applied respectively to the spot display items 76b and 76f of the “B amusement park” and the “F rent-a-car”, whereas genre-categorized tags 96 indicating that they are gourmet spots are applied to the spot display items 76g and 76h of the “G restaurant” and the “H restaurant”.

The background color of the genre-categorized tags 96 indicating gourmet spots is displayed in a darker color than the genre-categorized tags 78 pertaining to the tourist spots, and concerning other genre-categorized tags as well, for example, tags pertaining to lodgings (inns, hotels), the background color thereof is displayed such that the difference, including the color shade thereof, is made clear, so as to be easily distinguished from the other genre-categorized tags.

Furthermore, in the spot display items 76b, 76f, 76g, 76h, respectively, display regions 92b, 92f, 92g, 92h showing respective spot images are displayed in a small size. Concerning spot display items for which spot images are not registered (spot display items in which display regions are not included), corresponding small displays of the display regions are not performed. In addition, as noted above, when a bookmark is made, since candidate site data and position information are stored together in the candidate site DB 66, at that time, the candidate site data of all of the candidate sites that are displayed on the bookmark screen 80 are stored beforehand in the candidate site DB 66.

In step S12, if the user taps the selection button 86 and commands that the bookmark screen 80 be displayed, the visiting spot searching unit 36 issues a request to the server 14 to distribute the candidate site data and the position information. The distribution control unit 58 of the server 14 then distributes the candidate site data and the position information that are stored in the candidate site DB 66 to the terminal 12 through the communications network 18. Consequently, based on the distributed candidate site data and the position information, the visiting spot searching unit 36 can display on the display unit 34 the bookmark screen 80 of FIG. 5.

In step S13, if the user wants to create a visiting plan (step S13: YES), by tapping on a plan indicating message 98 displayed on the bookmark screen 80, the display unit 34 displays the map screen 82 of FIG. 6 instead of the bookmark screen 80 of FIG. 5.

In this case, when the visiting spot searching unit 36 accepts the tap made by the user on the plan indicating message 98, a request to distribute map information is made to the server 14, whereupon the distribution control unit 58 of the server 14 distributes the map information of the map DB 64 to the terminal 12 through the communications network 18. Consequently, based on the distributed map information, the visiting spot searching unit 36 can display on the display unit 34 the map screen 82 of FIG. 6.

In the following step S14 (third step), for example, in the case that the user inputs the “area A” to the text box 74 as a regional designation for the destination that the user wishes to visit (step S14: YES), then the destination area setting unit 38 issues a request to the server 14 to distribute the map information of the area A, the candidate site data including the bookmarked candidate sites (POI) within the area A, and the position information therefor. The distribution control unit 58 of the server 14 then distributes the map information of the area A within the map DB 64, along with the candidate site data and the position information of the area A within the candidate site DB 66, to the terminal 12 through the communications network 18.

As a result, based on the distributed map information, the destination area setting unit 38 displays the map screen 82 of “area A” on the display unit 34, together with displaying in an overlapped manner on the map screen 82 the bookmarked candidate sites (POI) within the area A (step S15 (third step)).

On the other hand, in step S14, in the case that a regional designation of a destination site the user desires to visit is not input from the user (step S14: NO), the destination area setting unit 38 displays on the display unit 34 a wide area map screen 82 in which all of the POIs can be displayed, so as to enable all of the spots (POIs) that are currently being bookmarked to be displayed (step S16 (third step)).

More specifically, the destination area setting unit 38 issues a request to the server 14 to distribute the candidate site data and the position information of all of the candidate sites (POIs) that have been bookmarked, and the map information including all of the candidate sites. The distribution control unit 58 of the server 14 then distributes all of the candidate site data and the position information in the candidate site DB 66, and map information of a wide area corresponding to all of the candidate sites in the map DB 64, to the terminal 12 through the communications network 18. As a result, based on the distributed map information, the destination area setting unit 38 displays the map screen 82 of the wide area including all of the candidate sites on the display unit 34, together with displaying in an overlapped manner on the map screen 82 all of the candidate sites (step S16).

In the following description, primarily, a description will be given concerning the creation of a visiting plan, for a case in which the user has designated the area A (step S14: YES, step S15).

FIG. 6 is a drawing illustrating the map screen 82 that is shown on the display unit 34 (step S15), for the case in which the user has designated the area A (step S14: YES).

Popup icons 102b, 102f to 102j of the bookmarked candidate sites (POIs) are arranged in the map screen 82. Further, to each of the popup icons 102b, 102f to 102j, there also are applied genre-categorized tags 104, 106, and display regions 108b, 108f to 108j in which images of the respective candidate sites are displayed. Accordingly, by observing each of the popup icons 102b, 102f to 102j, the user can get an overview of each of the candidate sites. Further, in each of the popup icons 102b, 102f to 102j, which are formed in the shape of balloons, origin points of such balloon-like shapes point to the respective candidate sites on the map screen 82.

Further, a message area 110 for notifying the number of the candidate sites (visiting spots) that have been selected in one visiting plan is displayed on the map screen 82. In this case, for creating the visiting plan in step S17 and subsequent steps, in the message area 110, among the seven candidate sites that have been bookmarked, the fact that none of the candidate sites has been selected is indicated by “0/7 items”.

Among the seven candidate sites that have been bookmarked, six candidate sites are displayed as popup icons 102b, 102f to 102j in the map screen 82. Since the popup icon 112 for the remaining one candidate site corresponds to a spot display item for which an image of the spot has not been registered, a display region of such an image is not shown on the map screen 82.

Further, the genre-categorized tags 104, 106 applied to the popup icons 102b, 102f to 102j correspond respectively to the genre-categorized tags 78, 96 of FIGS. 4 and 5. More specifically, the genre-categorized tags 78, 104 are tags that pertain to tourist spots, whereas the genre-categorized tags 96, 106 are tags that pertain to gourmet spots, the background color of which is shown in a darker color than that of the genre-categorized tags 78, 104.

Next, in step S17 (fourth step), the user taps on a desired popup icon, so as to select a candidate site (a visiting spot chosen as a POI) to be added to the visiting plan.

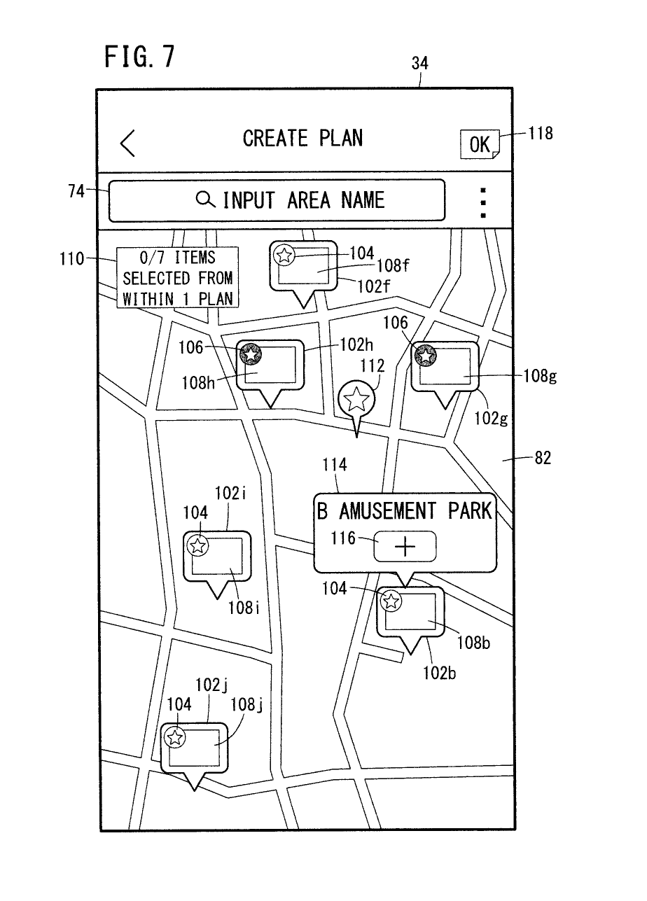

For example, as shown in FIG. 7, when the user taps the popup icon 102b, a balloon-like popup icon 114 is displayed in an overlapping manner with respect to the popup icon 102b. A selection button 116 is added to the popup icon 114. Accordingly, when the user taps on the selection button 116, the candidate site indicated by the popup icon 102b is selected as a visiting spot and is added to the visiting plan.

More specifically, when the candidate site adjusting unit 40 accepts the tap made by the user on the selection button 116, a request is made to register the selected candidate site as a visiting spot, to the server through the communications network 18. Based on the request from the terminal 12, the DB management unit 56 of the server 14 again registers as a visiting spot the selected candidate site that is registered in the candidate site DB 66.

Further, concerning the other popup icons (e.g., the popup icons 102f, 102g) that indicate other candidate sites, by the user making a selection thereof in the same manner as in the case of the popup icon 102b, the other candidate sites can be selected as visiting spots.

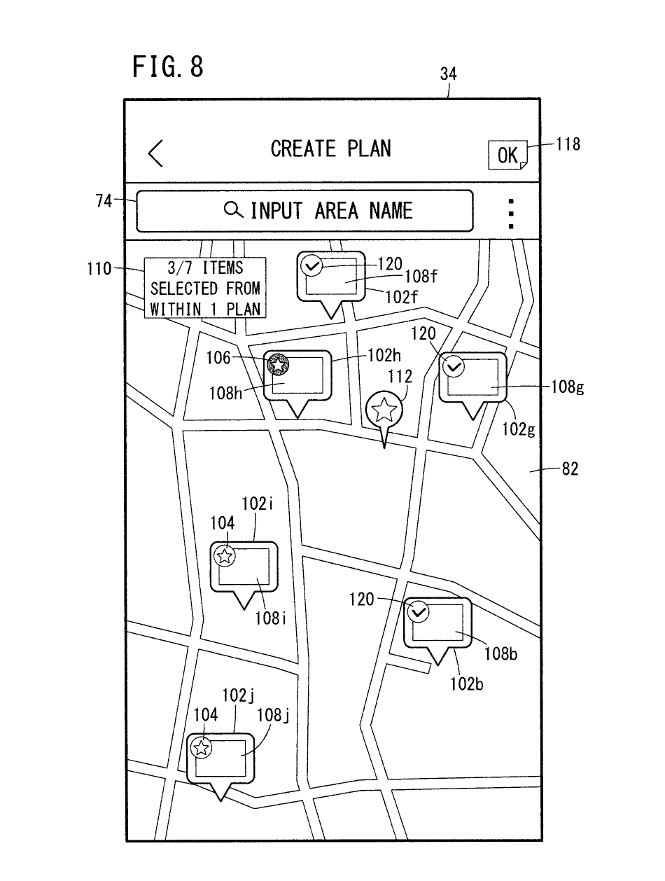

FIG. 8 illustrates displayed content of the map screen 82, for a case in which candidate sites indicated by the popup icons 102b, 102f, 102g are selected as visiting spots. In this case, instead of the genre-categorized tags 104, 106, selection-completion tags 120 are applied to the popup icons 102b, 102f, 102g to indicate that they have been selected as visiting spots. Further, in the message area 110, the message “3/7 items selected” is displayed, indicating that three candidate sites indicated by the popup icons 102b, 102f, 102g have been selected as visiting spots.

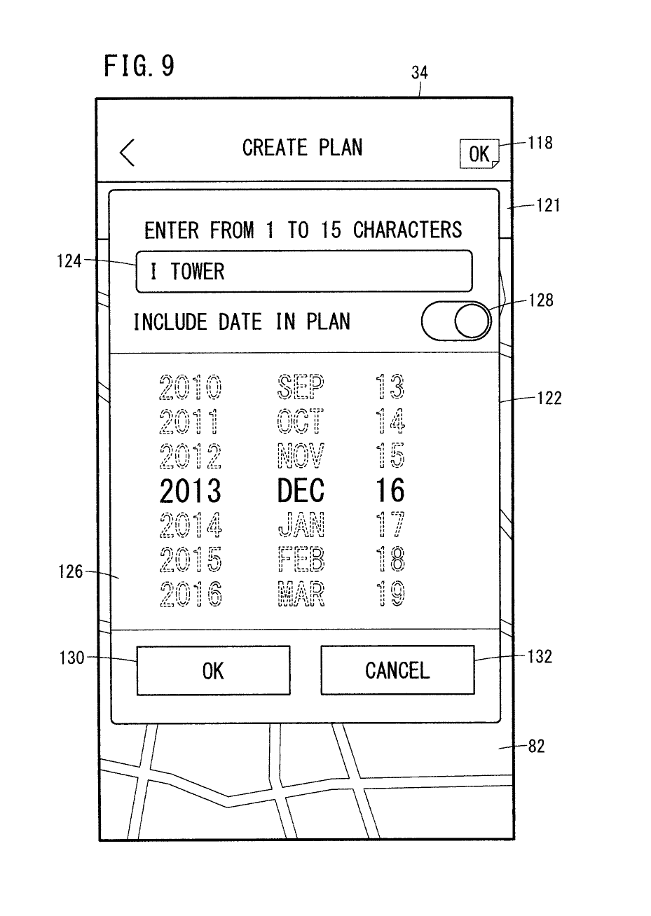

After the visiting spots have been selected in the foregoing manner, when the OK button 118 in FIG. 8 is tapped on, the display switches over to a plan registration screen 121 of FIG. 9. In step S18, while observing the plan registration screen 121, the user applies a name that the user can identify to the created visiting plan, and registers the plan with the name in the server 14. In the present embodiment, the name (plan name) of the visiting plan, and the date on which visiting spots are to be visited according to the visiting plan are set.

As shown in FIG. 9, when the user operates the operating unit 28, a setting display 122 is displayed in an overlapping manner over the map screen 82 that makes up the plan registration screen 121. In the setting display 122, there are shown a text box 124 for entering a plan name, a selection region 126 for selecting a date, an on/off button 128 for allowing or disallowing a selection operation of dates to be performed by the user with respect to the selection region 126, an OK button 130 for confirming the plan name and dates that were set by the user, and a cancel button 132 for canceling the plan name and dates that the user has entered.

Accordingly, after the user enters a plan name into the text box 124, turns on the on/off button 128, and selects a date (e.g., 2013 Dec. 16) using the selection region 126, when the OK button 130 is tapped on, the plan name for the created visiting plan, and the date on which the visit is to take place are registered.

More specifically, when the schedule adjusting unit 42 accepts the plan name and the date entered by the user, the server 14 is notified of the plan name and the date through the communications network 18. The DB management unit 56 of the server 14 applies the plan name and the date with respect to the candidate site data of the visiting spots that are registered in the candidate site DB 66, and manages the candidate site data. As a result, the visiting plan including the selected visiting spots is created, and the visiting plan is registered in the candidate site DB 66. Further, if the on/off button 128 is set to off, the date selection operation is disallowed, and therefore, it is also possible to register a visiting plan in which dates are not included.

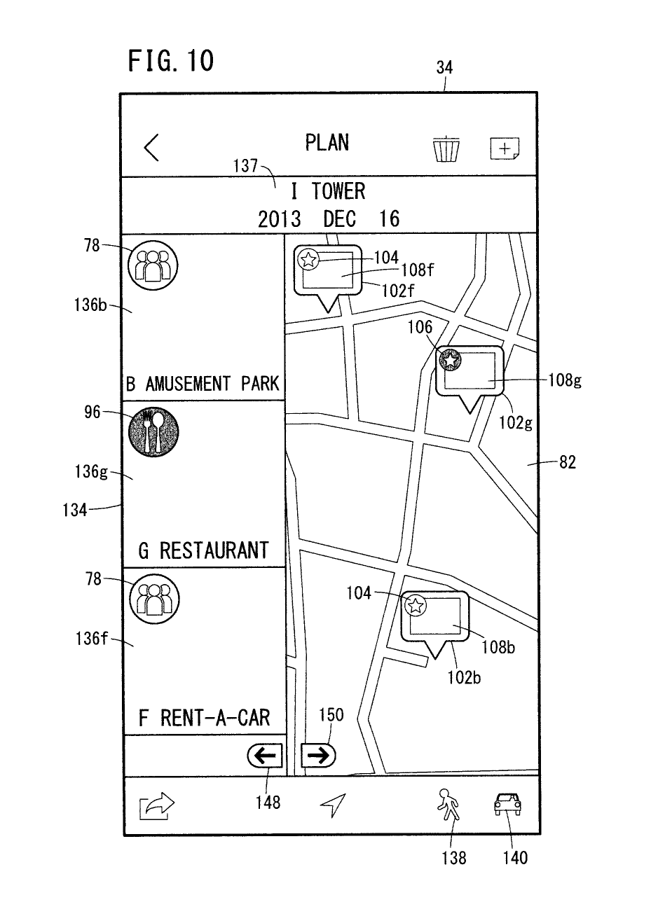

Next, in step S19 (fourth step), the schedule adjusting unit 42 issues a request to the server 14 through the communications network 18 to distribute the visiting plan. The distribution control unit 58 of the server 14 then distributes the visiting plan that is registered in the candidate site DB 66 to the terminal 12 through the communications network 18. As shown in FIG. 10, for displaying the distributed visiting plan on the display unit 34, the schedule adjusting unit 42 displays in parallel, i.e., alongside one another, the map screen 82, and a schedule display (schedule table) 134, which indicates the order in which the visiting spots are to be visited.

As shown in FIG. 10, on the display unit 34, the map screen 82 is displayed on the right-hand side, and the schedule display 134, which indicates the visiting order of the visiting spots contained within the visiting plan, is displayed on the left-hand side.

On the display unit 34, the schedule display 134 displays, from top to bottom, in the order in which they are to be visited, visiting spot display items (display labels) 136b, 136g, 136f that indicate the visiting spots. The genre-categorized tags 78, 96 are displayed in the visiting spot display items 136b, 136g, 136f. Further, on the display unit 34, a message 137, which includes the plan name “I TOWER” and the date “2013 Dec. 16”, is displayed.

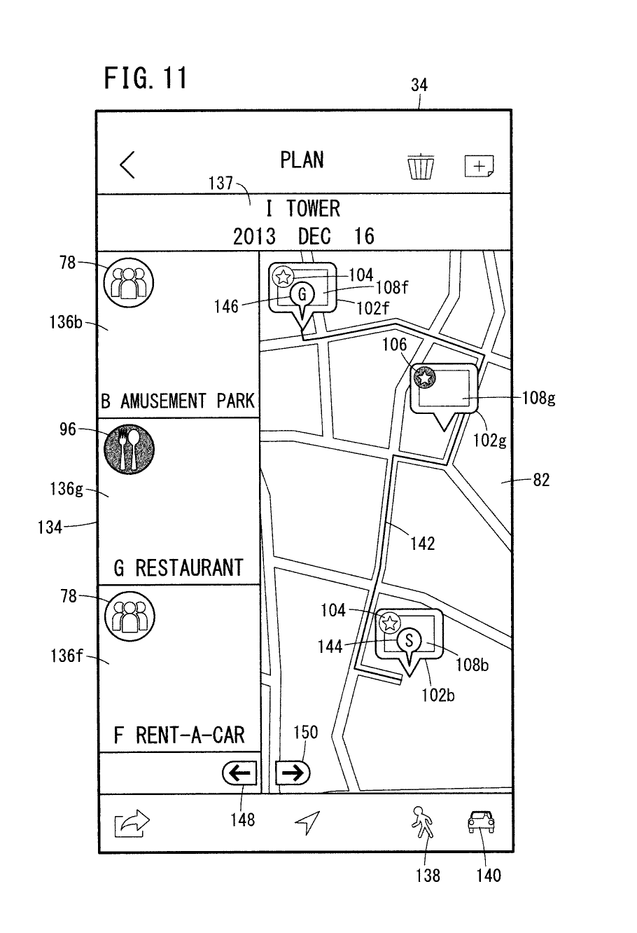

On a lower part of the display unit 34, a walking navigation button 138 and a vehicle navigation button 140 are displayed. If the user taps on the walking navigation button 138, then as shown in FIG. 11, a walking path (travel path) 142, from the “B amusement park” indicated by the popup icon 102b, passing by the “G restaurant” indicated by the popup icon 102g, and terminating at the “F rent-a-car” indicated by the popup icon 102f, is shown on the map screen 82.

In this case, a popup icon 144 indicating the departure point (“B amusement park”) of the walking path 142, and a popup icon 146 indicating the arrival point (“F rent-a-car”) of the walking path 142 are displayed together on the map screen 82. The character “S” is displayed on the popup icon 144 to indicate the departure point, whereas the character “G” is displayed on the popup icon 146 to indicate the arrival point.

Further, as shown in FIGS. 10 and 11, a full screen display button 148 for displaying the map screen 82 over the full screen by the user tapping thereon, and another full screen display button 150 for displaying the schedule display 134 over the full screen by the user tapping thereon are displayed on the schedule display 134.

Next, in the case that the user desires to adjust the visiting order or the visiting time (residence time) of the respective visiting spots in the created visiting plan (step S20: YES), the user may tap on the full screen display button 150.

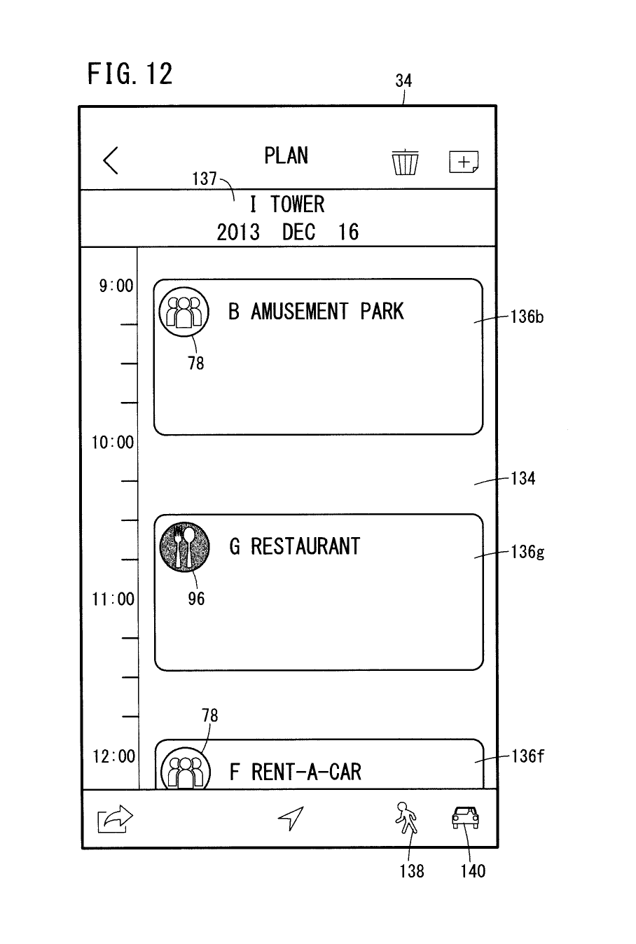

Accordingly, as shown in FIG. 12, the display of the display unit 34 switches to the full screen display mode of the schedule display 134 (step S21). In the full screen display shown in FIG. 12, a time axis is displayed from the top to the bottom, and along the time axis, the visiting spot display items 136b, 136g, 136f are arranged in the order in which they are to be visited. Further, in the schedule display 134, as default values, the visiting times (residence times) of the respective visiting spot display items 136b, 136g, 136f are each set to one hour.

By the user operating the display screen of the schedule display 134, the user can carry out adjustments to the visiting order and the visiting times of the POIs (step S22). For example, in the case that the user wishes to set the visiting time of the “B amusement park”, which is the first visiting spot, to a longer value, the user may perform a pinch-out maneuver in a vertical direction of the visiting spot display item 136b. Conversely, if the user wishes to set the visiting time of the “B amusement park” to a shorter value, the user may perform a pinch-in maneuver in a vertical direction of the visiting spot display item 136b.

By a similar operation, corresponding to pinch-out or pinch-in maneuvers of the user, the schedule adjusting unit 42 is capable of lengthening or shortening the residence times of the “G restaurant” and the “F rent-a-car” that are indicated by the visiting spot display items 136g, 136f.

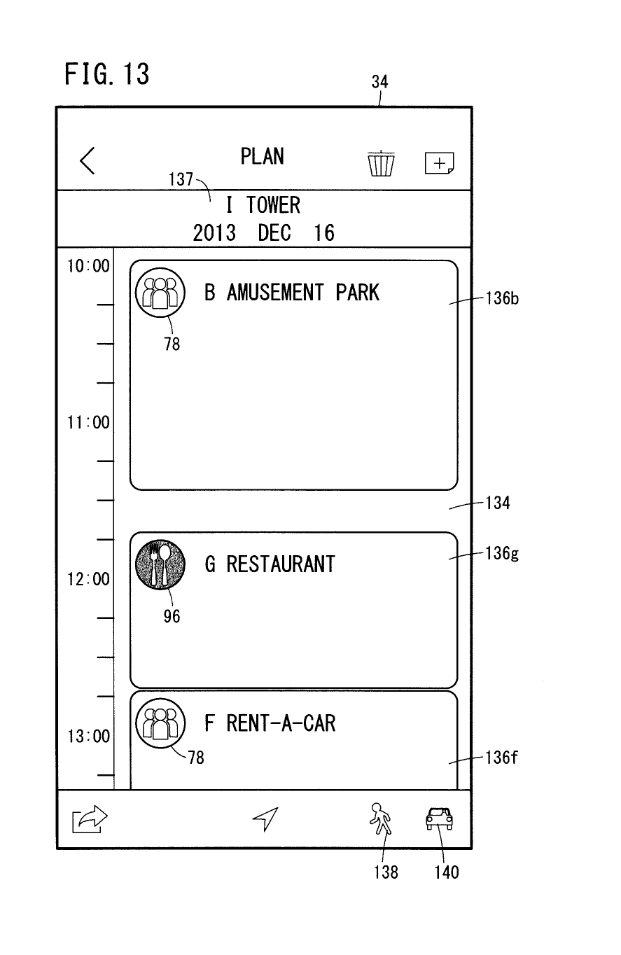

As a result, the schedule adjusting unit 42 is capable of switching the displayed content of the display unit 34 from the original visiting plan shown in FIG. 12 to the post-adjustment visiting plan shown in FIG. 13.

Further, although a case has been described above in which the visiting spot display items 136b, 136g, 136f are either pinched out or pinched in vertically, in the event that the visiting order of the visiting spots is to be changed, in a state in which the visiting spot display items 136b, 136g, 136f are pressed continuously (pressed and held), the visiting spot display items 136b, 136g, 136f may be moved while being dragged to a desired ordered position. In this manner, in the case that the user changes the display order of the visiting spot display items 136b, 136g, 136f, the schedule adjusting unit 42 can change the walking path 142 on the map screen 82 corresponding to the display order after change thereof. For example, if the display orders of the visiting spot display item 136b and the visiting spot display item 136g are interchanged, the schedule adjusting unit 42 displays on the map screen 82 a walking path 142, in which the departure point and the waypoint are reversed, and then finally, the “F rent-a-car” indicated by the visiting spot display item 136f is arrived at.

Furthermore, it has been described above that, by the user tapping the walking navigation button 138, the walking path 142 for a case for which the user travels by walking is displayed on the map screen 82. However, if the user wishes to travel by vehicle using an automobile or the like, the vehicle navigation button 140 may be tapped on. Accordingly, instead of the walking path 142 for walking, a travel path for a vehicle is displayed on the map screen 82.

In step S20, in the case that it is unnecessary to adjust the visiting order or the visiting times of the visiting spots (step S20: NO), then the processes of step S21 and step S22 are not carried out.

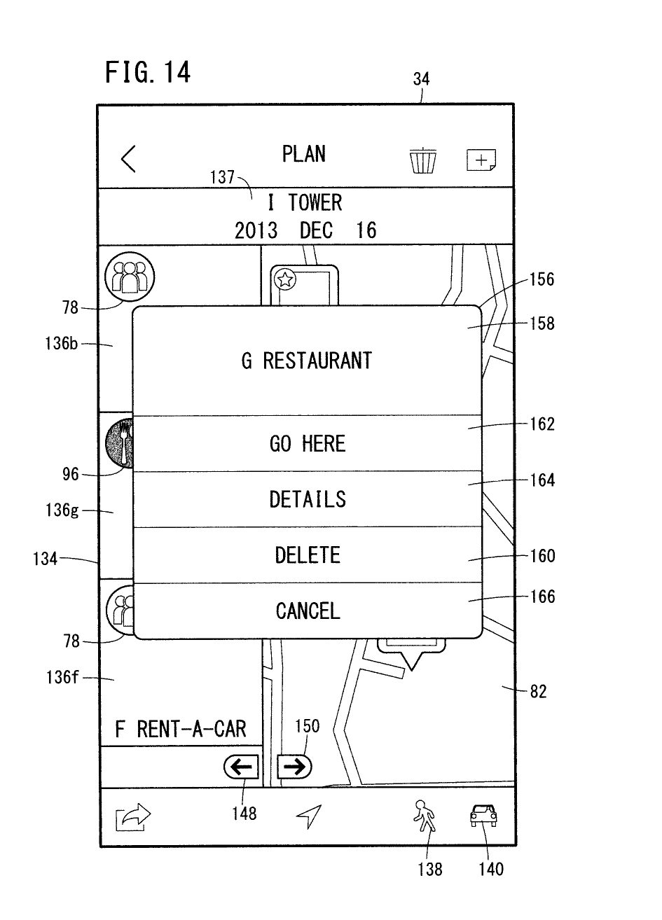

Next, in step 523, in the case that there is an unnecessary visiting spot (POI) (step S23: YES), the user operates the operating unit 28, whereby a visiting spot selection display 156 shown in FIG. 14 is displayed. A message 158 which indicates that the “G restaurant” has been selected for display is shown on the visiting spot selection display 156. In this case, when the user taps on a “delete” item 160 from within the visiting spot selection display 156, the “G restaurant” visiting spot is deleted from the visiting plan (step S24).

More specifically, when the schedule adjusting unit 42 accepts the tap made by the user on the “delete” item 160, a request is made to the server 16 through the communications network 18 to delete the candidate site data of the “G restaurant” from the visiting plan. The DB management unit 56 of the server 14 then deletes the candidate site data of the “G restaurant” from the visiting plan that is registered in the candidate site DB 66.

As a result, when a visiting plan after the above deletion is distributed to the terminal 12 from the server 14, the schedule adjusting unit 42 can display, on the display unit 34, the map screen 82 from which the popup icon 102g indicating the “G restaurant” has been deleted, and the schedule display 134 from which the visiting spot display item 136g has been deleted.

Moreover, on the visiting spot selection display 156, there also are displayed a spot display instruction item 162 for commanding that the “G restaurant” be displayed on the map screen 82 and the schedule display 134, a details display instruction item 164 for commanding that detailed information of the “G restaurant” be displayed, and a cancel item 166 for canceling the visiting spot selection display 156.

In step S23, in the case it is unnecessary to delete a visiting spot (step S23: NO), the process of step S24 is not carried out.

### Advantages of the Present Embodiment

As described above, according to the present embodiment, from a time at which the user undertakes the creation of a visiting plan for a trip or the like, spot information that has been researched in various ways over a wide area, and visiting spots such as tourist spots, gourmet spots, and museums or the like, which the user has always longed to visit, are stored in the candidate site DB as candidate site data indicative of candidate sites that match with the preferences of the user. In addition, when the user regionally designates a destination area (e.g., area A) that the user actually desires to visit, genre-categorized tags 104, 106 are applied to the candidate site data concerning candidate sites that are positioned inside of area A, and popup icons 102b, 102f to 102j concerning the candidate sites are displayed on a map screen 82 of the area A. Consequently, the positions of the candidate sites and the types (genres) of the candidate sites on the map screen 82 can be used as a reference or guide, and by the user operating the operating unit 28, visiting spots including the order in which they are to be visited can easily be selected.

Accordingly, all of the spots in which the user has shown interest are stored in the candidate site DB 66 as the candidate site data, and are displayed as popup icons 102b, 102f to 102j on the map screen 82 by the candidate site adjusting unit 40. As a result, in creating a visiting plan, such spots can reliably be established as selections under consideration, i.e., deserving of further study, by the user. Further, from the genre-categorized tags 104, 106 applied to the popup icons 102b, 102f to 102j corresponding to the respective candidate sites and the positional relationship between the candidate sites on the map screen 82, the user can easily select a combination of respective candidate sites in the order in which the sites are to be visited.

Furthermore, the visiting spot display items 136b, 136g, 136f, which serve as display labels corresponding to the respective candidate site data (information of the visiting spots) are fitted and displayed, in the order in which the visiting spots are to be visited, in the schedule display 134 that is displayed with a time axis, and since a walking path 142 between the respective candidate sites in the visiting order thereof is displayed on the map screen 82, the user can easily grasp an image of such movements and the approximate time required therefor.

Consequently, according to the present embodiment, without sacrificing the enjoyment that the user experiences in spending time selecting various visiting spots, the visiting spots can easily be selected from within a destination area to thereby create a visiting plan.

Further, the order in which plural visiting spot display items 136b, 136g, 136f shown in the schedule display 134 are displayed along the time axis can be changed in response to an operation of the operating unit 28 made by the user. In this case, if the user changes the display order thereof, the walking path 142 (travel path) between the candidate sites displayed on the map screen 82 also is changed. In accordance with this feature, since by operating the operating unit 28, the user can easily carry out an operation to interchange or swap the visiting order of the respective candidate sites, any number of schedules can easily be created and considered.

Further, with the present embodiment, the time width and the display position of the visiting spot display items 136b, 136g, 136f in the schedule display 134 can be adjusted, corresponding to the visiting time of the user or the traveling time of the user between the respective candidate sites. Owing thereto, the timewise precision of the visiting plan in the schedule display 134 can be increased. As a result, by the user confirming the schedule display 134, a temporal image of the created visiting plan can easily be grasped.

Furthermore, as a result of an operation of the operating unit 28 by the user, when a popup icon 102b, 102f, 102g corresponding to the visiting plan is deleted from the map screen 82, or when a visiting spot display item 136b, 136g, 136f is deleted from the schedule display 134, the candidate site data corresponding to such displays is deleted from the visiting plan that is recorded in the candidate site DB 66. Accordingly, candidate site data can easily be deleted from both a positional standpoint on the map screen 82 and a temporal standpoint in the schedule display 134.

Further still, when the schedule display 134 and the map screen 82 are displayed side by side, the visiting spot display items 136b, 136b, 136f, which are shown in the schedule display 134, and the popup icons 102b, 102g, 102f and the genre-categorized tags 104, 106 of the map screen are displayed respectively in association with each other. Consequently, the visiting plan can be adjusted while comparing alongside one another the positions of the visiting spots on the map screen 82 and the display positions of the visiting spot display items 136b, 136g, 136f.

Further, by associating the genre-categorized tags 78, 96 of the visiting spot display items 136b, 136g, 136f, with the popup icons 102b, 102g, 102f and the genre-categorized tags 104, 106, it is possible to display both of them in alignment, and positional confirmation of both items is extremely easy. For example, by using partial content (background colors) of the genre-categorized tags 78, 96 in association with the displayed content (background colors) of the genre-categorized tags 104, 106, candidate site data to which the genre-categorized tags 104, 106 have been applied can easily be distinguished from other candidate site data.

The present invention is not limited to the embodiment described above, and various changes and modifications may be made to the embodiment without departing from the scope of the invention as set forth in the appended claims.

What is claimed is:

1. A visiting plan creating system that supports a user of a terminal device in creating a visiting plan for visiting desired spots, based on data that are displayed on a display unit of the terminal device, by way of two-way communications between a server and the terminal device, the visiting plan creating system comprising:
a candidate site data searching unit that, as a result of an operation performed by the user on an operating unit of the terminal device, searches spot data corresponding to the operation from among a plurality of spot data indicative of spots capable of serving as visiting spots for the user, and sets the searched spot data as candidate site data indicative of candidate sites that match preferences of the user;
a candidate site storage unit that establishes a linkage between the candidate site data and position information of the candidate sites and stores the candidate site data and the position information;
a candidate site display processor that, when the user operates the operating unit and designates a destination area that the user desires to visit, based on the position information of the candidate sites linked therewith, preferentially searches candidate site data indicative of candidate sites inside of the destination area from among the candidate site data that are stored in the candidate site storage unit, and applies genre-categorized tags to the searched candidate site data in order to identify types of the visiting spots, and displays popup icons of the candidate site data on a map screen of the destination area that is displayed on the display unit; and
a guidance display processor that, when the user operates the operating unit to select some of the candidate site data that are displayed by the popup icons on the map screen, fits a display label corresponding to each of the selected candidate site data in a schedule table formed on a time axis in the order of selection, and displays the schedule table on the display unit, and according to a fitted order of the display labels, is capable of displaying on the map screen a travel path between the candidate sites indicated by the display labels.

2. The visiting plan creating system according to claim 1, wherein:
the guidance display processor is capable of changing a display order in which a plurality of the display labels are displayed along the time axis in the schedule table, corresponding to an operation of the operating unit made by the user; and
responsive to a change in the display order, the travel path between the candidate sites displayed on the map screen is changed and displayed.

3. The visiting plan creating system according to claim 1, wherein the guidance display processor is capable of adjusting a time width and a display position of each of the display labels in the schedule table, corresponding to a residence time of the user in the candidate site indicated by each of the display labels in the schedule table, and a travel time of the user between the candidate sites.

4. The visiting plan creating system according to claim 1, wherein candidate site data that has been selected by the user from among the candidate site data displayed by the popup icons can be deleted by deleting a corresponding popup icon from the map screen or by deleting a corresponding display label from the schedule table, as a result of an operation of the operating unit performed by the user.

5. The visiting plan creating system according to claim 1, wherein the display unit displays the schedule table and the map screen side by side, and displays in association with each other respectively the display labels in the schedule table together with the candidate site data and the genre-categorized tags that are displayed on the map screen.

6. A terminal device that supports a user in creating a visiting plan for visiting desired spots, based on data that are displayed on a display unit by way of two-way communications with a server, wherein the terminal device comprising:
an operating unit operated by the user;
a candidate site data searching unit that, as a result of an operation performed by the user on the operating unit, searches spot data corresponding to the operation from among a plurality of spot data indicative of spots capable of serving as visiting spots for the user, and sets the searched spot data as candidate site data indicative of candidate sites that match preferences of the user;
a candidate site display processor that, in a case that a linkage is established between the candidate site data and position information of the candidate sites, and the candidate site data and the position information are stored in a candidate site storage unit of the server, when the user operates the operating unit and designates a destination area that the user desires to visit, based on the position information of the candidate sites linked therewith, preferentially searches candidate site data indicative of candidate sites inside of the destination area from among the candidate site data that are stored in the candidate site storage unit, and applies genre-categorized tags to the searched candidate site data in order to identify types of the visiting spots, and displays popup icons of the candidate site data on a map screen of the destination area that is displayed on the display unit; and
a guidance display processor that, when the user operates the operating unit to select some of the candidate site data that are displayed by the popup icons on the map screen, fits a display label corresponding to each of the selected candidate site data in a schedule table formed on a time axis in the order of selection, and displays the schedule table on the display unit, and according to a fitted order of the display labels, is capable of displaying on the map screen a travel path between the candidate sites indicated by the display labels.

7. A visiting plan creating method that supports a user of a terminal device in creating a visiting plan for visiting desired spots, based on data that are displayed on a display unit of the terminal device, by way of two-way communications between a server and the terminal device, wherein the visiting plan creating method comprising:
a first step of searching, as a result of an operation performed by the user on an operating unit of the terminal device, spot data corresponding to the operation from among a plurality of spot data indicative of spots capable of serving as visiting spots for the user, and setting the searched spot data as candidate site data indicative of candidate sites that match preferences of the user;
a second step of establishing a linkage between the candidate site data and position information of the candidate sites and storing the candidate site data and the position information in a candidate site storage unit;
a third step of, when the user operates the operating unit and designates a destination area that the user desires to visit, based on the position information of the candidate sites linked therewith, preferentially searching candidate site data indicative of candidate sites inside of the destination area from among the candidate site data that are stored in the candidate site storage unit, and applying genre-categorized tags to the searched candidate site data in order to identify types of the visiting spots, and displaying popup icons of the candidate site data on a map screen of the destination area that is displayed on the display unit; and
a fourth step of, when the user operates the operating unit to select some of the candidate site data that are displayed by the popup icons on the map screen, fitting a display label corresponding to each of the selected candidate site data in a schedule table formed on a time axis in the order of selection, displaying the schedule table on the display unit, and according to a fitted order of the display labels, displaying on the map screen a travel path between the candidate sites indicated by the display labels.
